(19) United States
(12) Patent Application Publication
(10) Pub. No.: US 2005/0119403 A1
(43) Pub. Date: Jun. 2, 2005

(54) Solvent based, elastomeric coatings with lower VOC

(76) Inventor: David John St. Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 10/724,656

(22) Filed: Dec. 1, 2003

(51) Int. Cl. C08L 53/00

(52) U.S. Cl. 524/736; 525/88; 524/849; 524/847

(57) ABSTRACT

The present invention relates to solvent based coatings which have a low level of volatile organics compounds (VOC) meeting California VOC regulations and which can be spray applied as a coating on a variety of surfaces. The coating formulation comprises a hydrogenated styrene/butadiene triblock copolymer, a hydrogenated styrene/butadiene diblock copolymer, at least one hydrocarbon solvent, at least one VOC exempt solvent, a midblock tackifying resin, and a pigment or filler. The relative amounts of solvent, tackifying resin and pigment are adjusted to obtain a solvent based, elastomeric coating having a VOC content of no more than 250 grams per liter and a viscosity no higher than 2,000 centipoise @ 25° C. as measured according to ASTM D2196.

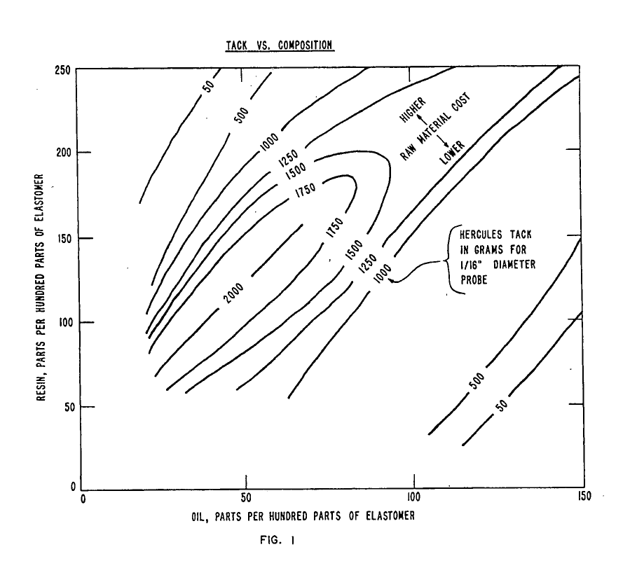

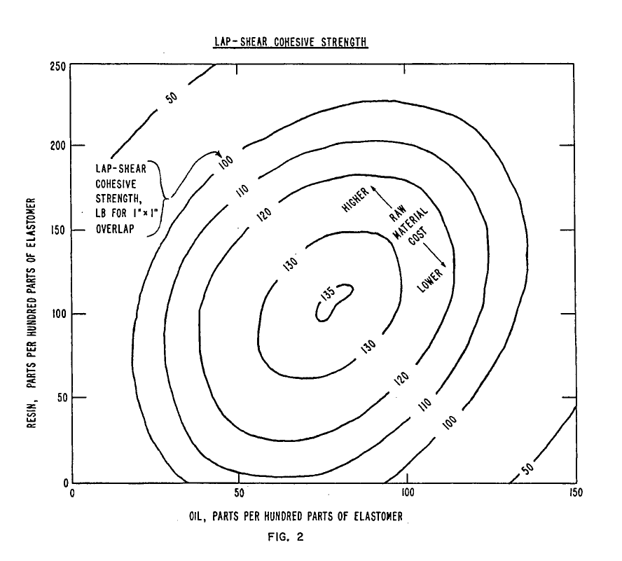

### BACKGROUND OF THE INVENTION

1. Field of the Invention

This invention relates to low viscosity, high solids content coatings which have a low level of volatile organics compounds (VOC) meeting California VOC regulations and which can be spray applied as a coating on a variety of surfaces.

2. Background of the Art

Styrenic block copolymers (“SBC's”) have a long history of use in adhesives, sealants and coatings. For example, U.S. Pat. No. 3,239,478 (“Harlan”) discloses adhesives comprising unsaturated styrene-isoprene-styrene block copolymers (“SIS”) and styrene-butadiene-styrene block copolymers (“SBS”) in adhesives and sealants. Harlan also broadly discloses adhesives comprising the hydrogenated S-B-S (i.e. “SEBS”) and hydrogenated S-I-S (i.e. “SEPS”) block copolymers with tackifying resins and extender oils for a variety of adhesives and sealants, including pressure sensitive adhesives.

The most widely used elastomeric coatings (as opposed to adhesives and sealants) are water based coatings where the elastomeric polymer is an emulsion polymerized acrylic. Water based acrylic coatings have an excellent reputation for performance and, since they are nearly solvent-free, they readily meet government restrictions on emission of Volatile Organic Compounds (VOC). The main disadvantage of water based coatings is that they dry slowly in humid environments and can be damaged if they are rained upon before they dry. Application of solvent based coatings is much less sensitive to environmental conditions. However, use of solvent based coatings is limited by government restrictions on allowable emission of VOC. In architectural coatings, for example, if the product falls in the Coating Category of “Roof Coatings”, many VOC regulations limit the VOC content to 250 g/L. At least one regulation on architectural coatings has a special category called “Thermoplastic Rubber Coatings and Mastics” which allows VOC to be as high as 550 g/L. In the aerospace industry, VOC of coatings for chemical milling is limited to 160 or 250 g/L, depending on the type of etchant bath that is used.

Hydrogenated, styrenic block copolymers are good candidates for use in such solvent based, elastomeric coatings. These polymers are strong and elastic and, because they are hydrogenated, they have good durability in exterior applications and good resistance to degradation in the strongly acidic or basic solutions used for chemical milling. However, typical solvent based formulations with the current commercial hydrogenated SBC's do not give VOC levels below 250 g/L while at the same time having acceptable viscosity for use in spray applied use, such as for applying a coating to a roofing membrane. If such a product were available, it would have a number of advantages over current formulations.

Now a novel anionic block copolymer has been discovered and patentee has found that this novel block copolymer can be formulated to give coatings which can be spray applied and which meet California VOC restrictions. Patentee has also found that these coatings are more stretchy and elastic than the acrylic coatings which are used today.

### SUMMARY OF THE INVENTION

One aspect of the present invention is the discovery of a novel low viscosity coating composition comprising:
a. 100 parts by weight of a hydrogenated block copolymer composition comprising two block copolymer components—i.e. about 20 to about 40 weight percent of a triblock copolymer having the general configuration of (A¹-B¹)₂X where X is the coupling agent residue or A²-B²-A³ and about 80 to about 60 weight percent of a diblock copolymer having the general configuration of A¹-B¹ or A⁴-B³;
b. about 25 to about 150 parts by weight of at least one midblock tackifying resin;
c. about 25 to about 150 parts by weight of a filler or pigment; and
d. about 150 to about 250 parts by weight of a mixture of at least one hydrocarbon solvent and at least one VOC exempt solvent, in a weight ratio of VOC exempt solvent to hydrocarbon solvent of between about 35:65 and about 65:35.

The hydrogenated block copolymers have at least one polymer block A and at least one polymer block B wherein (a.) prior to hydrogenation each A block is styrene homopolymer block and each B block is a 1,3-butadiene homopolymer block; (b.) subsequent to hydrogenation about 0-10% of the styrene double bonds have been reduced, and at least about 90% of the butadiene double bonds have been reduced; (c.) each A¹, A², A³ and A⁴ block having a number average molecular weight between about 5,000 and about 10,000; each B¹ and B³ block having a number average molecular weight between about 12,000 and about 30,000; and each B² block having a molecular weight about twice the molecular weight of the B¹ block; and (d.) the total amount of styrene in the hydrogenated block copolymer composition is about 41 weight percent to about 50 weight percent.

In another aspect of the present invention it has been shown that the relative amounts of solvent, tackifying resin and pigment can be adjusted to obtain a solvent based, elastomeric coating having a VOC content of no more than 250 grams per liter and a viscosity no higher than 2,000 centipoise @ 25° C. as measured according to ASTM D2196.

### DETAILED DESCRIPTION OF THE PREFERRED EMBODIMENTS

One of the key components of the present invention is the novel block copolymer composition comprising two block copolymer components—one being a triblock copolymer having the general configuration of (A¹-B¹)₂X or A²-B²-A³ and the second being a diblock copolymer having the general configuration of A¹-B¹ or A⁴-B³. Prior to hydrogenation the A blocks are styrene homopolymer blocks and the B blocks are 1,3-butadiene homopolymer blocks.

The method to prepare this thermoplastic block copolymer is via any of the methods generally known for block polymerizations. The preferred process is an alkyl lithium anionic polymerization in an inert solvent, such as that disclosed in U.S. Pat. No. 3,239,478. In the case of the diblock copolymer, one block is the styrene-based homopolymer block and polymerized therewith is a second block of a butadiene polymer. In the case of the triblock composition, it comprises, as end-blocks the glassy styrene-based homopolymer and as a mid-block the butadiene block. The A-B-A, triblock compositions can be made by either sequential polymerization or coupling. In the sequential solution polymerization technique, the styrene is first introduced to produce the first styrene block, followed by introduction of the butadiene to form the mid block, and then followed by introduction of the styrene to form the terminal block. In addition to the linear, A-B-A configuration, the blocks can be structured to form a coupled polymer, (A-B)₂X. Coupling is the preferred means to produce both the triblock copolymer and the diblock copolymer by controlling the coupling efficiency of the coupling reaction. Preferred coupling agents are those that result in primarily linear two arm products, and include methyl benzoate, certain alkoxy silanes and certain diepoxides. The alkoxy silanes used herein have the general formula R₂—Si—(OR′)₂, where R and R′ are the same or different, R is selected from aryl, linear alkyl and branched alkyl hydrocarbon radicals, and R′ is selected from linear and branched alkyl hydrocarbon radicals. The aryl radicals preferably have from 6 to 12 carbon atoms. The alkyl radicals preferably have 1 to 12 carbon atoms, more preferably from 1 to 4 carbon atoms. The preferred silane is dimethyl dimethoxy silane. Coupling efficiency would be controlled so as to produce both the triblock copolymer and the diblock copolymer at the desired amounts. Accordingly, coupling efficiencies of 20 to 40 weight percent, preferably 25 to 35 weight percent are desired.

It is also important to control the molecular weight of the various blocks. For an AB diblock, desired block weights are 5,000 to about 10,000 daltons for the styrene A blocks, and 5,000 to about 15,000 for the hydrogenated B block. Preferred ranges are 6,000 to 9,000 for the A block and about 8,000 to about 12,000 for the B block. For the triblock, which may be a sequential ABA or coupled (AB)₂X block copolymer, the A blocks should be 5,000 to about 10,000, preferably 6000 to about 9,000, while the B block for the sequential block should be about 12,000 to about 30,000, and the B blocks (two) for the coupled polymer half that amount. The total average molecular weight for the triblock copolymer should be from about 17,000 to about 40,000. These molecular weights are most accurately determined by light scattering measurements, and are expressed as number average molecular weights. One of the most important aspects of the present invention is the control of the styrene content of the block copolymer composition. As shown in the examples which follow, it is important to maintain the overall styrene content between 41 weight percent and about 50 weight percent. Because of the higher styrene content of this block copolymer composition, it will have a better solubility in the VOC exempt solvents, making it easier to keep VOC levels low, while also resulting in the lower viscosity needed for spray applications.

Another important aspect of the present invention is to control the microstructure or vinyl content of the butadiene in the B blocks. The term “vinyl content” refers to a conjugated diene, i.e. butadiene, which is polymerized via 1,2-addition. The term “vinyl” refers to the presence of a pendant vinyl group on the polymer chain. When referring to the use of butadiene as the conjugated diene, it is preferred that about 30 to about 60 mol percent of the condensed butadiene units in the copolymer block have 1,2 vinyl configuration as determined by proton NMR analysis, preferably about 35 to about 55 mol percent of the condensed butadiene units should have 1,2-vinyl configuration. This is effectively controlled by varying the relative amount of the distribution agent. Suitable ratios of distribution agent to lithium are disclosed and taught in U.S. Pat. Re 27,145, which disclosure is incorporated by reference.

The block copolymer is selectively hydrogenated. Hydrogenation can be carried out via any of the several hydrogenation or selective hydrogenation processes known in the prior art. For example, such hydrogenation has been accomplished using methods such as those taught in, for example, U.S. Pat. Nos. 3,494,942; 3,634,594; 3,670,054; 3,700,633; and Re. 27,145. Hydrogenation can be carried out under such conditions that at least about 90 percent of the butadiene double bonds have been reduced, and between zero and 10 percent of the styrene double bonds have been reduced. Preferred ranges are at least about 95 percent of the butadiene double bonds reduced, and more preferably about 98 percent of the butadiene double bonds are reduced.

One of the other components used in the coatings of the present invention is a tackifying resin. Tackifying resins used herein are termed mid block compatible resins. Resins compatible with the hydrogenated (mid) block may be selected from the group consisting of compatible C₅ hydrocarbon resins, hydrogenated C₅ hydrocarbon resins, styrenated C₅ resins, C₅/Cg resins, styrenated terpene resins, fully hydrogenated or partially hydrogenated Cg hydrocarbon resins, rosins esters, rosin derivatives and mixtures thereof. These resins are e.g. sold under the trademarks “REGALITE”, “REGALREZ”, “ESCOREZ”, “WINGTACK”, “EASTOTAC” and “ARKON”. Preferred resins include Escorez 5300 from Exxon, a hydrogenated C₅ midblock resin having a softening point of 105° C., Eastotac H-100W from Eastman Chemical, a hydrogenated C₅ midblock resin having a softening point of 100° C. and Regalrez 1018 from Eastman, a hydrogenated C₅ midblock resin having a softening point of 18° C. and a Tg of about −20° C. The relative amount of tackifying resin in the formulation depends upon the adhesion requirements and the balance of mechanical properties desired in the coating. Typical levels are about 25 to about 150 parts by weight, per 100 parts by weight of the rubber, preferably about 75 to about 125 parts by weight.

Various types of fillers and pigments can be included in the coating formulations to pigment the coating and also reduce cost. Suitable fillers include calcium carbonate, clay, talc, silica, zinc oxide, titanium dioxide and the like. The amount of filler usually is in the range of about 25 to about 150 parts by weight, depending on the type of filler used and the application for which the adhesive is intended. Preferably the amount of filler used is about 40 to about 100 parts by weight. Especially preferred as filler is titanium dioxide.

A very important aspect of the present invention is the use of two different solvents for the block copolymer. In the past toluene was the solvent of choice, because it has about the right evaporation rate for coatings and because it is a good solvent for both the polystyrene end blocks and the rubber mid block of the block copolymer. However, toluene is not VOC exempt, and government regulations put strict limits on the amount of toluene which a coating can contain because toluene is a VOC. Table 1 shows some solvents which are alternatives to toluene which can reduce VOC. Heptane is also a VOC but, because of its lower density, a liter of coating contains a lower weight of solvent. Therefore, its contribution to VOC in units of grams of solvent per liter of coating is less than toluene. Outside data show that heptane also has less tendency to generate ozone. However, while heptane is a good solvent for the rubber mid block, it does not dissolve the polystyrene end blocks of the block copolymer. Therefore two different solvents are required—one to dissolve the rubber midblock and one to dissolve the polystyrene end blocks. In the present formulations, one of the solvents is a hydrocarbon solvent and the other is a VOC exempt solvent. Some solvents are considered by the government regulators to be VOC exempt because they have little tendency to form ozone. Acetone and p-chlorobenzotriflouride (PCBTF) are exempt solvents and exempt status is expected soon for t-butyl acetate (tBAc). Acetone is an inexpensive solvent but its use is limited by its fast evaporation rate and its low flash point. PCBTF (KESSCHEM 100 from Kessler Chemical) has fairly good evaporation characteristics but it is expensive and has high density. TBAc is a very attractive solvent because it has the right evaporation characteristics, it is reasonably priced and it has density typical of common solvents. Regulations for Consumer Products also have a category called Low Vapor Pressure (LVP) solvents which are considered to be VOC exempt. Solvents which have >12 carbon atoms fall into this category. Conosol C-200 (from Penreco), which is a mixture of C₁₂-C₁₆ isoparaffin/cycloparaffin molecules, is an example of an LVP solvent.

Regarding the choice for hydrocarbon solvents, preferred are the aliphatic hydrocarbon solvents such as heptane, hexane, naphtha or mineral spirits. Most preferred is heptane. Preferred VOC exempt solvents are acetone, p-chlorobenzotrifluoride and t-butyl acetate (assuming it becomes VOC exempt). The type and amount of each solvent can be adjusted to obtain the appropriate level of solids, which will not only meet VOC requirements, but also will have the right drying characteristics to give a high quality, smooth, pinhole-free, stress-free coating. Starting amounts to consider are about 75 to about 125 parts by weight of hydrocarbon solvent and about 75 to about 125 parts by weight of VOC exempt solvent. The weight ratio of VOC exempt solvent to hydrocarbon solvent should be about 35:65 to 65:35, preferably about 50:50.

TABLE 1
Characteristics of Potential Solvents

| | Boiling | Flash | Density, | O₃ Formation | VOC |
|---|---|---|---|---|---|
| Solvent | Point, ° C. | Point, ° C. | gm/cc | Potential, Kg/gal | Exempt |
| Toluene | 110 | 5 | 0.87 | 16.7 | No |
| Heptane | 98 | −1 | 0.68 | 2.3 | No |
| Acetone | 56 | −20 | 0.79 | 0.7 | Yes |
| PCBTF | 140 | 45 | 1.36 | 0.6 | Yes |
| t-Butyl | 98 | 15 | 0.86 | 0.4 | Soon? |
| Acetate | | | | | |
| Conosol | 235-280 | 100 | 0.82 | — | Yes |
| C-200 | | | | | |

The compositions of the present invention maybe modified further with the addition of other antioxidants, stabilizers, flame retardants, anti blocking agents, lubricants and other rubber and plastic compounding ingredients without departing from the scope of this invention. Such components are disclosed in various patents including U.S. Pat. No. 3,239,478 and U.S. Pat. No 5,777,043, the disclosures of which are incorporated by reference.

The compositions of the present invention maybe designed for a wide variety of uses and applications. A preferred application would be for spray application on roofing surfaces, to waterproof the roof and to pigment the roof to whatever color is desired. Another preferred application would be as a coating for chemical milling of metals as, for example, milling aluminum for aircraft parts.

Regarding the relative amounts of the various ingredients, this will depend in part upon the particular end use and on the particular block copolymer that is selected for the particular end use. Preferred ranges are given, and the following examples will be helpful in determining the appropriate formulation.

### EXAMPLES

The following examples are provided to illustrate the present invention. The examples are not intended to limit the scope of the present invention and they should not be so interpreted. Amounts are in weight parts or weight percentages unless otherwise indicated. American Society for Testing Materials (ASTM) test method D-2196 was used to measure Brookfield viscosity @ 25° C.

The following components were used in the various examples:

| Ingredient | Description |
|---|---|
| SBC #1 | S-EB₄₀-S(7-34-7), 30% w S, Tg = −55° C. |
| SBC #2 | S-EB₄₀(7-17)₂, 30% w S, 30% Coupled, Tg = −55° C. |
| SBC #3 | S—S/EB₄₀-S(7-9/25-7), 46% w S, Tg = −25° C. |
| SBC #4 | S-EB₆₅-S(8-40-10), 28% w S, Tg = −38° C. |
| SBC #5 | S-EB₄₀(7.5-12)₂, 42% wS, 30% Coupled, |
| | Tg = −55° C. |
| Escorez 5300 | Hydrogenated C₅ midblock resin, SP = 105° C. |
| Eastotac H-100W | Hydrogenated C₅ midblock resin, SP = 100° C. |
| Regalrez 1018 | Hydrogenated C₉ midblock resin, SP = 18° C., |
| | Tg = −20° C. |
| TiPure R-902 | Rutile TiO₂, 0.42 micron particle size |
| Irganox 1010 | Hindered phenol type antioxidant, MP = 110-125° C. |
| Toluene | Solvent, BP = 110° C. |
| Heptane | Solvent, BP = 98° C. |
| Acetone | Solvent, BP = 56° C. |
| t-Butyl Acetate | Solvent, BP = 98° C. |
| Kesschem 100 | p-chlorobenzotriflouride (PCBTF), BP = 140° C. |
| Conosol C-200 | Solvent, BP = 235-280° C. |

SBC's 1 and 2 are commercial block copolymers, while SBC's 3,4 and 5 are pre-commercial products. SBC #5 is the block copolymer composition according to the present invention. Regarding the polymer descriptions, the following explanation of SBC #1 applies to all polymers. SBC #1 is a hydrogenated styrene-butadiene-styrene sequential block copolymer (i.e. S-EB-S) where the butadiene block prior to hydrogenation has 40 mol % 1,2-vinyl content, the molecular weights of the three blocks are 7,000-34,000-7,000, it has 30% by weight polystyrene content, and the mid block has a Tg of −55° C. SBC # 3 and 4 are also sequential polymers. SBC polymers # 2 and 5 are coupled polymers having a coupling efficiency of 30% (i.e. 30% by weight of triblock and 70% by weight of diblock).

### Example 1

It would seem that, by using VOC exempt solvents, a formulator should be able to make a solvent based coating having zero VOC. This is not the case, however, because many commercial hydrogenated styrene butadiene block copolymers are not soluble in the VOC exempt solvents. This is shown by the data in Table 2 which gives the Brookfield viscosity at 25° C. of SBC #1 at 20% w in these solvents. Results show that SBC #1 will not dissolve in heptane. Heptane is a good solvent for the rubber segment of the polymer but it does not dissolve the polystyrene endblocks of the polymer. So the polymer merely swells in heptane to give a clear, soft gel. Polar solvents, such as acetone, PCBTF and tBAc are good solvents for polystyrene but not for the rubber phase of the polymer. Therefore, it is expected that SBC #1 will dissolve in blends of heptane with a polar solvent because heptane will dissolve the rubber segment and the polar solvent will dissolve the polystyrene segments of the polymer.

Results in Table 2 show that SBC #1 dissolves readily in an 80/20 ratio by weight of heptane/acetone, giving viscosity of only 350 cps. A solvent blend containing 40% w acetone is too polar to dissolve the polymer. SBC #1 is not soluble in PCBTF but it will dissolve in blends of heptane/PCBTF over the range of 80/20 to 20/80. However, the viscosity is a minimum at 60/40 heptane/PCBTF, showing that this blend is the most effective for dissolving both segments of the polymer. SBC #1 also dissolves in blends of heptane/tBAc over the range of 80/20 to 40/60. Again, minimum viscosity is found at 60/40 heptane/tBAc, showing that this is the most effective blend. Thus, good solvent blends to use are an 80/20 blend of heptane/acetone or a 60/40 blend of heptane/PCBTF or heptane/tBAc. Also good solvent blends are a 60/20/20 blend of heptane/acetone/PCBTF or heptane/acetone/tBAc.

TABLE 2
Viscosity of SBC #1 at 20% w in Solvent Blends

| | |
|---|---|
| Solvent Blend | Viscosity, cps, |
| Ratio, w/w | if 2^{nd} Solvent is |

| Heptane | 2^{nd} Solvent | Acetone | PCBTF | TBAc |
|---|---|---|---|---|
| 100 | 0 | Gel | gel | gel |
| 80 | 20 | 350 | 850 | 580 |
| 60 | 40 | Insoluble | 530 | 310 |
| 40 | 60 | | 855 | 550 |
| 20 | 80 | | 2,170 | gel |
| 0 | 100 | | gel | |

### Example 2

A good candidate for making elastomeric coatings is SBC #1 using a blend of heptane and tBAc (assuming tBAc is declared to be VOC exempt). Table 3 shows potential approaches to a clear coating having a balance of VOC and viscosity with this system. A formulation at 40% w solids in a good solvent such as the 60/40 heptane/tBAc blend has a viscosity just over 5,000 cps and VOC of 380 g/L (Formulation 1). A lower viscosity can be achieved by reducing the solids content to 35% w but this increases VOC to 415 g/L (Formulation 2). If it was desired to reach 350 g/L, calculations show that one can keep the solids content of the coating at 40% w and reduce the heptane/tBAc ratio to 50/50 (Formulation 3) or keep the solids content at 35% w and reduce the heptane/tBAc ratio to 40/60 (Formulation 4). Both approaches give readily handleable viscosity. Thus, it is simple to make coatings having 350 g/L VOC.

Results show it is much more difficult to reach 250 g/L VOC. If it is desired to keep the solids content at 40% w, calculations show that the heptane/tBAc ratio would have to be reduced to 27/73 (Formulation 5). Since this is a marginal solvent for the polymer, the viscosity of this formulation is 20,000 cps. One could also reduce the solids content to 35% w. Calculations show that the heptane/tBAc ratio in this formulation would have to be reduced to 22/78 to reach 250 g/L (Formulation 6). Results show that, at 8,000 cps viscosity, this coating would be difficult to apply. Thus, it is unlikely that a clear, elastomeric coating having 2,000 cps viscosity at 25° C. can be made with SBC #1 at 250 g/L VOC.

TABLE 3
Clear, Elastomeric Coatings at VOC of 350 g/L or 250 g/L
(in heptane/tBAc, assuming tBAc is VOC exempt)

| Component, | | | | | | |
|---|---|---|---|---|---|---|
| pbw | 1 | 2 | 3 | 4 | 5 | 6 |
| SBC #1 | 100 | 100 | 100 | 100 | 100 | 100 |
| EASTOTAC | 67 | 67 | 67 | 67 | 67 | 67 |
| H-100W | | | | | | |
| Stabilizers | 4 | 4 | 4 | 4 | 4 | 4 |
| TIPURE R-902 | 0 | 0 | 0 | 0 | 0 | 0 |
| Heptane | 154 | 190 | 128 | 127 | 69 | 70 |
| t-Butyl Acetate | 103 | 127 | 128 | 190 | 187 | 247 |
| Heptane/tBAc | 60/40 | 60/40 | 50/50 | 40/60 | 27/73 | 22/78 |
| Ratio | | | | | | |
| Solids Content, | 40 | 35 | 40 | 35 | 40 | 35 |
| % w | | | | | | |
| Calculated | 380 | 415 | 350 | 350 | 250 | 250 |
| VOC, g/L | | | | | | |
| Viscosity @ | 5,300 | 1,100 | 5,500 | 1,900 | 20,000 | 8,000 |
| 25° C., cps | | | | | | |

### Example 3

Table 4 shows various approaches to achieving a balance of VOC and viscosity for white coatings containing 100 pbw TiO₂ using SBC #1 or #2 and heptane/tBAc blends (assuming tBAc is declared to be VOC exempt) or heptane/PCBTF. Formulation 1 uses a 60/40 blend of heptane/VOC exempt solvent, which is a good solvent blend for SBC #1 and which calculates to a VOC of 430 g/L. At 40% w solids, Formulation 1 has a viscosity of 1,000 cps in heptane/tBAc and 1,700 cps in heptane/PCBTF. Keeping the solids content at 40% w, calculations show that one can reach 350 g/L VOC with SBC #1 by reducing the heptane/exempt solvent ratio to 36/64 (Formulation 2). Results in Table 4 show this coating has a readily handleable viscosity of 1,600 cps in heptane/tBAc and 2,600 cps in heptane/PCBTF. To reach a VOC of 250 g/L at 40% w solids, the heptane/exempt solvent ratio would have to be 20/80 with SBC #1 (Formulation 3). Results presented earlier in Table 2 showed that a 20/80 heptane/tBAc blend is a marginal solvent for the polymer and, as expected, this coating has considerably higher viscosity in heptane/tBAc of 7,100 cps. Results in Table 2 showed that SBC #1 will dissolve in a 20/80 heptane/PCBTF blend and results in Table 4 show viscosity of Formulation 3 is only somewhat higher than Formulation 2.

Because of its lower viscosity, SBC #2 may be a better candidate for achieving white coatings having 250 g/L VOC. Results on Formulation 4 in Table 4 show that replacing SBC #1 by SBC #2 allows the solids content to increase to 50% w at about constant viscosity, reducing the VOC from 430 to 370. VOC of 350 g/L can be reached by reducing the heptane/exempt solvent ratio to 53/47 giving Formulation 5 only slightly higher viscosity than Formulation 4. To reach 250 g/L VOC at 50% w solids, the heptane/exempt solvent ratio must be reduced to 30/70. Formulation 6 has viscosity of 3,700 cps in heptane/tBAc and 6,100 cps in heptane/PCBTF. Thus, SBC #2 is a better candidate for low VOC coatings but further formulating work is necessary to reach 250 g/L at 2,000 cps viscosity at 25° C.

TABLE 4
White, Elastomeric Coatings at VOC of 350 g/L or 250 g/L

| Component, | | | | | | |
|---|---|---|---|---|---|---|
| pbw | 1 | 2 | 3 | 4 | 5 | 6 |
| SBC #1 | 100 | 100 | 100 | | | |
| SBC #2 | | | | 100 | 100 | 100 |
| EASTOTAC | 67 | 67 | 67 | 67 | 67 | 67 |
| H-100W | | | | | | |
| Stabilizers | 4 | 4 | 4 | 4 | 4 | 4 |
| TIPURE R-902 | 100 | 100 | 100 | 100 | 100 | 100 |
| Heptane | 244 | 146 | 81 | 163 | 144 | 81 |
| tBAc or | 163 | 260 | 325 | 108 | 127 | 190 |
| PCBTF | | | | | | |
| Heptane/ | 60/40 | 36/64 | 20/80 | 60/40 | 53/47 | 30/70 |
| Exempt Ratio | | | | | | |
| Solids Content, | 40 | 40 | 40 | 50 | 50 | 50 |
| % w | | | | | | |
| Calculated | 430 | 350 | 250 | 370 | 350 | 250 |
| VOC, g/L | | | | | | |
| Viscosity @ | | | | | | |
| 25° C., cps | | | | | | |
| in heptane/ | 1,000 | 1,600 | 7,100 | 1,300 | 1,500 | 3,700 |
| tBAc | | | | | | |
| in heptane/ | 1,700 | 2,800 | 5,500 | 3,100 | 4,100 | 6,100 |
| PCBTF | | | | | | |

### Example 4

It was not possible to reach a VOC content of 250 g/L at a viscosity of 2,000 cps with either SBC #1 or SBC #2. A better polymer would be one which was inherently lower viscosity or one which had better solubility in VOC exempt solvents. Three approaches to a better polymer have been investigated. SBC #3 has the same structure as SBC #1 except 25% w of the butadiene in the rubber block was replaced with styrene. This has the effect of putting more carbon atoms in side chains and fewer in the backbone, thereby giving a polymer which is inherently lower viscosity than SBC #1. This also increases the styrene content of SBC #3 to 46% w which may improve solubility in VOC exempt solvents. SBC #4 has the same structure as SBC #1 except the 1,2-butadiene addition was increased from the usual 40% in SBC #1 to 65% in SBC #4. This also puts more carbon atoms in side chains, thereby giving a polymer which is inherently lower viscosity. SBC #5 has the same structure as SBC #2 except the midblock size was reduced until the styrene content reached 42% w. This not only gives a polymer which is inherently lower viscosity but, because of its higher styrene content, it may also have better solubility in VOC exempt solvents.

Results show that both SBC #3 and SBC #4 are inherently lower viscosity in a clear coating formulation vs. solids content in toluene than SBC #1 and that SBC #5 is lower viscosity than SBC #2. For example, the solids contents at which the polymers in this formulation have 2,000 cps viscosity in toluene are:

| KRATON Polymer | % w Solids @ 2000 cps |
|---|---|
| SBC #1 | 37.5 |
| SBC #3 | 44.0 |
| SBC #4 | 49.5 |
| SBC #2 | 50.5 |
| SBC #5 | 56.0 |

Table 5 shows the viscosity of solutions of the polymers at 20% w in blends of heptane with PCBTF or tBAc. Again SBC #3 and SBC #4 not only give lower viscosity than SBC #1 but they also dissolve in solvent blends containing higher fractions of VOC exempt solvent. Both polymers dissolve fairly well in PCBTF with no heptane. SBC #5 gives very low viscosity and is soluble in PCBTF or tBAc with no heptane. Thus, all three of the experimental polymers are better candidates for use in low VOC coatings than SBC #1 and SBC #2.

Table 6 shows formulations based on SBC #5 with a high Tg midblock resin (Eastotac H-100W), a low Tg midblock resin (Regalrez 1018) and TiO₂ in a 50/50 heptane/tBAc solvent blend which is considered a good solvent for the polymer. Comparison of formulations 1 and 2 shows that simply replacing SBC #2 by SBC #5 reduces the viscosity from about 2,000 cps to 1,200 cps. Results on formulations 3 and 4 show that addition of R-1018 is an effective approach for further reducing viscosity. Addition of 23.5 pbw or 55 pbw of R-1018 reduces the viscosity to 450 cps or 150 cps, respectively. Results on formulations 5 and 6 show that, at about 2,000 cps viscosity, solids contents can be increased to about 57% w or about 63% w in formulations containing 23.5 pbw and 55 pbw R-1018, respectively. Qualitatively, films of formulations 3 and 5 feel about the same as a film of formulation 1. Films of 4 and 6 feel somewhat softer than formulation 1 but they are still in a reasonable range for an elastomeric coating.

In Table 6, the formulations were maintained constant on a pbw basis. On a % w basis, as R-1018 was added, the amount of polymer in the formulation was reduced. Results in Table 7 show formulations where, as R-1018 was added, TiO₂ was removed in order to restore the polymer content back to the original concentration on a % w basis. For comparison, formulations 2, 5 and 6 from Table 6 are reproduced as formulations 1, 2 and 3 in Table 7. Calculations show that addition of 23.5 pbw or 55 pbw R-1018 reduces the concentration of SBC #5 from 37.2 to 34.2 or 30.9% w, respectively. Results on formulations 4 and 5 in Table 7 show that replacing TiO₂ by an equal amount of R-1018, thereby maintaining the SBC #5 concentration at 37.2% w, increases the viscosity somewhat. However, results show that, with minor adjustments in solids contents and solvent compositions, it will be possible to make coatings which have 2,000 cps viscosity at 250 g/L VOC with any of formulations 2-5 in Table 7.

TABLE 5
Solution Viscosity at 20% w Polymer in Solvent Blends

| Solvent | | | Brookfield Viscosity | | | | |
|---|---|---|---|---|---|---|---|
| Composition, % w | | | at 25° C., cps | | | | |
| Heptane | PCBTF | tBAc | SBC #1 | SBC #3 | SBC #4 | SBC #2 | SBC #5 |
| 100 | | | Clear | 3,590 | Clear | 1,020 | 4,000 |
| | | | gel | | gel | | |
| 80 | 20 | | 850 | 180 | 190 | 89 | 79 |
| 60 | 40 | | 530 | 185 | 82 | 74 | 42 |
| 40 | 60 | | 855 | 300 | 110 | 110 | 53 |
| 20 | 80 | | 2,170 | 610 | 195 | 220 | 98 |
| | 100 | | Clear | 1,980 | 730 | | 430 |
| | | | gel | | | | |
| 80 | | 20 | 580 | 125 | 175 | 62 | 59 |
| 60 | | 40 | 310 | 110 | 55 | 56 | 28 |
| 40 | | 60 | 550 | 190 | 58 | 71 | 30 |
| 20 | | 80 | Clear | 270 | 79 | 350 | 61 |
| | | | gel | | | | |
| | | 100 | a) | 9,300 | Bluish | b) | 26 |
| | | | | | gel | | |

a). Looked like opaque applesauce.
b). Bottom 30% was clear, fused pellets; top 70% was thin, opalescent blue liquid.

TABLE 6
Formulations at Constant pbw Composition Containing Regalrez 1018

| Component, pbw | 1 | 2 | 3 | 4 | 5 | 6 |
|---|---|---|---|---|---|---|
| SBC #2 | 100 | | | | | |
| SBC #5 | | 100 | 100 | 100 | 100 | 100 |
| EASTOTAC | 67 | 67 | 67 | 67 | 67 | 67 |
| H-100W | | | | | | |
| REGALREZ 1018 | | | 23.5 | 55 | 23.5 | 55 |
| TIPURE R-902 | 100 | 100 | 100 | 100 | 100 | 100 |
| IRGANOX 1010 | 2 | 2 | 2 | 2 | 2 | 2 |
| Heptane | 135 | 135 | 146 | 162 | 106 | 99 |
| t-Butyl Acetate | 135 | 135 | 146 | 162 | 106 | 99 |
| Solids Content, % w | 50 | 50 | 50 | 50 | 58 | 62 |
| Viscosity @ | 2,000 | 1,200 | 460 | 150 | 2,300 | 1,300 |
| 25° C., cps | | | | | | |

TABLE 7
Formulations at Constant % w Composition Containing Regalrez 1018

| Component, pbw | 1 | 2 | 3 | 4 | 5 |
|---|---|---|---|---|---|
| SBC #5 | 100 | 100 | 100 | 100 | 100 |
| EASTOTAC H-100W | 67 | 67 | 67 | 67 | 67 |
| REGALREZ 1018 | | 23.5 | 55 | 23.5 | 55 |
| TIPURE R-902 | 100 | 100 | 100 | 76 | 45 |
| IRGANOX 1010 | 2 | 2 | 2 | 2 | 2 |
| Heptane | 135 | 106 | 99 | 97 | 82 |
| t-Butyl Acetate | 135 | 106 | 99 | 97 | 82 |
| Solids Content, % w | 50 | 58 | 62 | 58 | 62 |
| Calculated VOC, g/L | 335 | 280 | 250 | 270 | 200 |
| Solids Composition, % w | | | | | |
| SBC #5 | 37.2 | 34.2 | 30.9 | 37.2 | 37.2 |
| EASTOTAC H-100W | 24.9 | 22.9 | 20.7 | 24.9 | 24.9 |
| REGALREZ 1018 | | 8.0 | 17.0 | 8.8 | 20.4 |
| TIPURE R-902 | 37.2 | 34.2 | 30.9 | 28.3 | 16.7 |
| IRGANOX 1010 | 0.7 | 0.7 | 0.6 | 0.7 | 0.7 |
| Viscosity @ 25° C., cps | | | | | |
| @ 100 rpm | 1,200 | 2,300 | 1,300 | 2,100 | 2,500 |
| @ 50 rpm | 1,900 | 3,300 | 2,100 | 2,900 | 2,900 |
| @ 20 rpm | 3,500 | 5,700 | 3,600 | 4,900 | 3,700 |
| @ 10 rpm | 5,400 | 8,700 | 5,200 | 7,400 | 4,600 |

If a product is labeled “Thermoplastic Rubber Coating”, some regulations allow VOC as high as 550 g/L. A white coating based on SBC #1 at 40% w solids using just toluene as the solvent has a VOC of about 600 g/L. So only a small amount of toluene needs to be replaced with a VOC exempt solvent to bring the VOC into compliance. However, if the product is labeled “Roof Coating”, VOC is limited to less than 250 g/L. Results presented here offer ideas on how to reduce the VOC of solvent based, elastomeric coatings. Results show that the VOC of the coating will be influenced by which SBC polymer is chosen for use in the coating and by the concentration of filler in the formulation. Results show that replacing toluene as the solvent in the coating based on SBC #1 with a blend of 60% heptane and 40% VOC exempt solvent can reduce VOC to about 430 g/L at 2,000 cps viscosity. However, at 250 g/L VOC, the best formulation using the lowest viscosity polymer, SBC #2, had 3,700 cps viscosity. Therefore, further formulating work will be required to reach 250 g/L at the target 2,000 cps viscosity using the commercial polymers. Experimental polymers demonstrating three different approaches to lower VOC coatings show promise because they are inherently lower viscosity and they have better solubility in VOC exempt solvents. Results show that it is possible to formulate a coating having 2,000 cps viscosity at 250 g/L VOC with SBC #5.

1. A composition having a low Volatile Organic Compounds level comprises 100 parts by weight of a selectively hydrogenated block copolymer composition dissolved in a mixture of one or more hydrocarbon solvents and one or more VOC-exempt solvents, wherein:
a. said selected hydrogenated block copolymer composition comprises about 20 to about 40 weight percent of a triblock copolymer having the general configuration (A¹-B¹)₂X or A²-B²-A³ where X is the residue of a coupling agent and about 80 to about 60 weight percent of a diblock copolymer having the general configuration A¹-B¹ or A⁴-B³ wherein:
i. prior to hydrogenation the A¹, A², A³ and A⁴ blocks are styrene homopolymer blocks and the B¹, B² and B³ blocks are 1,3-butadiene homopolymer blocks where about 30 to about 60 mol percent of the condensed butadiene units in the B blocks have 1,2-configuration,
ii. subsequent to hydrogenation about 0 to 10% of the styrene double bonds have been reduced and at least 90% of the butadiene double bonds have been reduced,
iii. each A¹, A², A³ and A⁴ blocks have a number average molecular weight of about 5,000 to about 10,000, and
iv. the total amount of styrene in the hydrogenated block copolymer composition is 41% by weight to about 50% by weight, and
b. the weight ratio of VOC-exempt solvents to hydrocarbon solvent is about 35;65 to about 65:35.

2. The composition of claim 1 further comprising about 25 to about 150 parts by weight of a midblock compatible tackifying resin.

3. The composition of claim 2 further comprising about 25 to about 150 parts by weight of a filler or pigment.

4. The composition of claim 3 wherein said hydrocarbon solvent is selected from the group consisting of hexane, heptane, toluene and xylene.

5. The composition of claim 4 wherein said VOC exempt solvent is selected from the group consisting of acetone, p-chlorobenzotrifluoride and t-butyl acetate.

6. The composition of claim 5 wherein said hydrocarbon solvent is heptane and said VOC exempt solvent is t-butyl acetate, where the amount of heptane is about 75 to about 125 parts by weight and the amount of t-butyl acetate is about 75 to about 125 parts by weight.

7. The composition of claim 6 wherein the weight ratio of heptane to t-butyl acetate is about 50:50.

8. The composition of claim 7 wherein said tackifying resin is a mixture of a hydrogenated C5 midblock resin and a hydrogenated C9 midblock resin.

9. The composition of claim 8 wherein said pigment is titanium dioxide.

10. The composition of claim 9 wherein the relative amounts of solvent, tackifying resin and pigment are adjusted to obtain a solvent based, elastomeric coating having a VOC content of no more than 250 grams per liter and a viscosity no higher than 2,000 centipoise @25° C. as measured according to ASTM D2196.

11. (canceled)

12. A composition having a low Volatile Organic Compounds level, said composition comprising 100 parts by weight of a selectively hydrogenated block copolymer composition dissolved in a mixture of about 99 parts by weight of heptane and about 99 parts by weight of t-butyl acetate, a midblock compatible tackifying resin that is a mixture of 67 parts by weight of a hydrogenated C⁵ midblock resin and 55 parts by weight of a hydrogenated C9 midblock resin, about 100 parts by weight of a titanium dioxide pigment, and about 2 parts by weight of an hindered phenol type antioxidant wherein:
a. said selected hydrogenated block copolymer composition comprises about 20 to about 40 weight percent of a triblock copolymer having the general configuration (A¹-B¹)₂X or A²-B²-A³ where X is the residue of a coupling agent and about 80 to about 60 weight percent of a diblock copolymer having the general configuration A¹-B¹ or A⁴-B³ wherein:
i. prior to hydrogenation the A¹, A², A³ and A⁴ blocks are styrene homopolymer blocks and the B¹, B² and B³ blocks are 1,3-butadiene homopolymer blocks where about 30 to about 60 mol percent of the condensed butadiene units in the B blocks have 1,2-configuration,
ii. subsequent to hydrogenation about 0 to 10% of the styrene double bonds have been reduced and at least 90% of the butadiene double bonds have been reduced,
iii each A¹, A², A³ and A⁴ blocks have a number average molecular weight of about 5,000 to about 10,000, and
iv. the total amount of styrene in the hydrogenated block copolymer composition is 41% by weight to about 50% by weight, and
b. wherein the solvent based, elastomeric coating has a VOC content of not more than 250 grams per liter and a viscosity no higher than 2,000 centipoise @ 25° C. as measured according to ASTM D2196.
